(19) United States
(12) Patent Application Publication
(10) Pub. No.: US 2001/0041772 A1
(43) Pub. Date: Nov. 15, 2001

(54) Thermoplastic elastomer composition

(76) Inventors: Tetsuo Masubuchi, Kanagawa (JP); Seiji Odashima, Kanagawa (JP)

Correspondence Address: BIRCH STEWART KOLASCH & BIRCH, PO BOX 747, FALLS CHURCH, VA, 22040-0747, US

(21) Appl. No.: 09/769,432

(22) Filed: Jan. 26, 2001

(30) Foreign Application Priority Data
Jan. 28, 2000 (JP) P.2000-019710

(51) Int. Cl. C08F 8/00

(52) U.S. Cl. 525/107

(57) ABSTRACT

A thermoplastic elastomer composition comprising the following components (A), (B) and (C): (A) 100 parts by weight of a thermoplastic polyester elastomer; (B) 3 to 100 parts by weight of a modified olefin resin having an epoxy group or a derivative group thereof in its molecule; and (C) 10 to 900 parts by weight of a rubbery elastomer selected from the group consisting of an olefin-based thermoplastic elastomers and styrene-based thermoplastic elastomers.

### FIELD OF THE INVENTION

The present invention relates to a thermoplastic elastomer composition, which can be used as a material for various molding products and which is excellent in flaw resistance (scratch resistance) on the surface of its molded product and also excellent in flexibility, heat resistance, oil resistance, properties at a low temperature, weatherability, strength and fabrication properties.

### BACKGROUND OF THE INVENTION

As use for automobile parts, electrical appliances, medical material parts and general merchandises, vulcanized rubber has been conventionally used. However, recently instead of the vulcanized rubber, thermoplastic elastomers having an excellent productivity are often used. As the example thereof, mention may be made of an olefinic elastomer comprising ethylene-propylene copolymer and polypropylene, polyurethane elastomer and soft polyvinylchloride.

However, it is the present state that these molding materials each have disadvantages in any of scratch resistance, flexibility, processability, economical efficiency and recycling property. Namely, the olefinic elastomer, although being relatively cheap and excellent in weatherability and heat resistance, has poor flexibility and scratch resistance. The polyester type elastomer has an excellent scratch resistance, but disadvantageously has a large specific gravity and is expensive. The soft vinyl chloride, although being relatively cheap, and excellent in weatherability and scratch resistance, has disadvantages of poor flexibility at a low temperature and poor recycling property.

Regarding an elastomer composition using a hydrogenated derivative of a vinyl aromatic compound-conjugated diene compound block copolymer (hereinafter, abbreviated as a “hydrogenated block copolymer”), several proposals have been also made. For example, JP-A-50-14742 (The term “JP-A” as used herein means an “unexamined published Japanese patent application”), JP-A-52-65551 and JP-A-58-206644 disclose a composition obtained by blending a softening agent for rubber and an olefinic resin with a hydrogenated block copolymer. However, these compositions are also poor in scratch resistance like the olefinic elastomer.

Further, also regarding a composition using a polyester-based elastomer, several proposals have been made. For example, JP-A-6-207086, JP-A-6-228419, JP-A-6-240446, JP-A-9-132700, JP-A-9-227760 and JP-A-10-7878, propose a thermoplastic elastomer composition comprising a polyester elastomer with which other various kinds elastomers or modified (having a functional group) elastomers are blended. However, the composition has such problems as insufficient compatibility among various components or poor fabrication property because of an excessive crosslinking reaction. Further, in the composition, an expensive modified-elastomer is used in a large amount and, therefore, the composition also has a problem in the cost.

### SUMMARY OF THE INVENTION

The present invention was made to solve the above-described problems in conventional techniques.

Accordingly, an object of the invention is to provide a thermoplastic elastomer excellent in flexibility, weatherability, heat resistance, oil resistance, properties at a low temperature, strength and fabrication property.

Other objects and effects of the present invention will become more apparent from the following description.

The above-described objects of the present invention have been achieved by providing a thermoplastic elastomer composition comprising the following components (A), (B) and (C):

(A) 100 parts by weight of a thermoplastic polyester elastomer;

(B) 3 to 100 parts by weight of a modified olefin resin having an epoxy group or a derivative group thereof in its molecule; and

(C) 10 to 900 parts by weight of a rubbery elastomer selected from the group consisting of an olefin-based thermoplastic elastomers and styrene-based thermoplastic elastomers.

### DETAILED DESCRIPTION OF THE INVENTION

The present invention is described in more detail below.

The thermoplastic polyester elastomer used as component (A) in the present invention, although being excellent in heat resistance, cold resistance, oil resistance and toughness, is generally relatively expensive as compared with generally used thermoplastic elastomers such as styrene-, olefinic- and vinyl chloride-based thermoplastic elastomers. Therefore, it is mainly used in functional parts such as automobile parts, parts of general industrial products, and electric and electronic parts.

The polyester elastomer of the present invention is a polyester block copolymer comprising a high melting point hard segment comprising aromatic polyester units and a low melting soft segment comprising aliphatic polyether units and/or aliphatic polyester units. The former is a polyester-polyether block copolymer, and the latter is a polyester-polyester block copolymer. The polyester-polyether block copolymer is a generally used-type block copolymer having balanced flexibility, thermal resistance, cold resistance, chemical resistance and moldability. On the other hand, the polyester-polyester block copolymer is excellent, particularly, in heat resistance, weatherability and mechanical strength.

As a typical low melting point soft segment constituent component of the polyester-polyether block copolymer of the present invention, polyether glycols such as polyoxyethylene glycol, polyoxypropylene glycol and polyoxytetramethylene glycol, a mixture thereof and a copolymerized polyether glycol obtained by copolymerizing the polyether constituent components can be mentioned. As a typical low melting point soft segment constituent component of the polyester-polyester block copolymer of the present invention, mention may be made of a polyester comprising an aliphatic or alicyclic dicarboxylic acid having 2 to 12 carbon atoms and an aliphatic or alicyclic glycol having 2 to 10 carbon atoms. For example, aliphatic polyesters such as polyethylene adipate, polytetramethylene adipate, polyethylene sebacate, polyneopentyl sebacate, polytetramethylnene decanoate, polytetramethylene azelate, polyhexamethylene azelate and poly ε-caprolactom; and aliphatic copolyesters produced by using two kinds of aliphatic dicarboxylic acids and two kinds of glycols can be mentioned. Further, as the low melting point soft segment constituent component, polyester-polyether block copolymers comprising a combination of the above-described aliphatic polyesters and aliphatic polyethers also can be mentioned.

A preferred example of the polyester-polyether block copolymer is one obtained by copolymerizing: (a) a short chain dicarboxylic acid component comprising an aromatic dicarboxylic acid and/or its ester-forming derivative; (b) a short chain diol component comprising an aliphatic diol; and (c) a long chain diol component which comprises a polyether glycol comprising a tetramethylene oxide structural unit represented by the following formula (1) (hereinafter abbreviated as “unit T”) and having alcoholic hydroxyl groups at both terminals and having a number-average molecular weight of 400 to 6,000.

T: —CH₂CH₂CH₂CH₂O— (1)

As component (a), i.e., an aromatic dicarboxylic acid and/or its ester-forming derivative, mention may be made of terephthalic acid, isophthalic acid, phthalic acid, naphthalene-2,6-dicarboxylic acid, naphthalene-2,7-dicarboxylic acid, diphenyl-4,4-dicarboxylic acid, diphenoxyethane dicarboxylic acid, 5-sulfoisophthalic acid and/or their ester-forming derivatives.

Further, alicyclic and aliphatic dicarboxylic acids such as 1,4-cyclohexane dicarboxylic acid, succinic acid, oxalic acid, adipic acid, sebacic acid, dodecanoic diacid and diner acid, and/or their ester-forming derivatives can be used. They can be used alone or in any mixture thereof. Preferably, terephthalic acid, isophthalic acid or naphthalene-2,6-dicarboxylic acid is used.

As component (b), i.e., aliphatic diol, generally a diol having a molecular weight of 300 or less is used. For example, mention may be made of ethylene glycol, 1,3-propylene diol, 1,4-butane diol, pentamethylene glycol, hexamethylene glycol, neopentyl glycol and decamethylene glycol.

Further, mention also may be made of alicyclic diols such as 1,1-cyclohexane dimethanol, 1,4-cyclohexane dimethanol and tricyclodecane dimethanol; xylilene glycol, bis (p-hydroxy)diphenyl, bis(p-hydroxyphenyl)propane, 2,2-bis(4-(2-hydroxyethoxy)phenyl)propane, bis(4-(2-hydroxy)phenyl)sulfone and 1,1-bis(4-(2-hydroxyethoxy)phenyl)cyclohexane. Preferably, mention may be made of ethylene glycol and 1,4-butne diol.

A hard segment of a polyether ester block copolymer, i.e., short chain polyester, is constructed by a combination of the above-described aromatic dicarboxylic acid and/or its ester-forming derivative with an aliphatic diol. A combination of terephthalic acid or diester of terephthalic acid with ethylene glycol or 1,4-butane diol (polyethylene terephthalate, polybutylene terephthalate) is preferred. More preferably, polybutylene terephthalate is used as the hard segment.

This is because the polybutylene terephthalate has a high crystallization rate so that it may have an excellent moldability and the polyether ester block copolymer produced therefrom has well balanced rubber elasticity, mechanical properties, thermal resistance and chemical resistance. In addition to these combinations, other dicarboxylic acids and/or their ester-forming derivatives in an amount of 15 mol % or less, or other diols in an amount of 15 mol % or less can be used.

Component (c) which forms the low melting point soft segment, namely, the polyether glycol, which constitutes a long chain polyester, comprises unit T, has alcoholic hydoxyl groups at both terminals and has a number-average molecular weight of 400 to 6,000.

As the polyester-polyether block copolymer of the present invention, it can be suitably used a polyester-polyether block copolymer obtained by copolymerization using, as the long chain diol component (component (c)), a polyether glycol comprising unit T represented by the following formula (1) and a neopentylene oxide structural unit represented by the following formula (2) (hereinafter abbreviated as unit N), having a proportion of unit N of 5 to 50 mol %, preferably 10 to 20 mol %, alcoholic hydoxyl groups at both terminals and a number-average molecular weight of 400 to 6,000.

T: —CH₂CH₂CH₂CH₂O— (1)

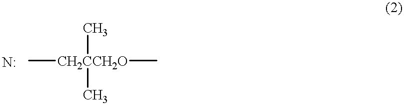

In a case where a copolymerized polyether comprising units T and N is used as the long chain diol component, i.e., component (c), the elastomer composition of the present invention is particularly preferred because properties at a low temperature, rubber elasticity, flexibility and soft feeling of the composition become further excellent.

The production method of the polyether glycol, which is used as component (C) constituting a long chain polyester and which comprises unit T, is not particularly limited. For example, mention may be made of the diol obtained by ring-opening polymerization of tetrahydrofuran in the presence of a heteropoly acid catalyst.

In the polyester-polyether block copolymer of the present invention using the polyether glycol, which constitutes a long chain polyester, comprising units T and N, the polyether glycol used in the production of the polyether ester block copolymer can be produced by homo-cation polymerization of 3,3-dimethyloxetane (3,3-DMO); cation copolymerization of 3,3-DMO and neopentyl glycol (NPG); cation copolymerization of 3,3-DMO and tetrahydrofuran (THF); terpolymerization of 3,3-DMO, NPG and THF. Alternatively, it can be produced by using neopentyl glycol and tetrahydrofuran as starting materials under the reaction conditions wherein depolymerization of pure tetramethylene glycol proceeds in the presence of a catalyst showing an activity in the presence of an alcoholic hydroxyl group.

In a case where a polyether glycol having a copolymerization ratio of unit N of less than 5 mol % is used, the resulting polyether ester block copolymer may have insufficient physical properties particularly in a performance at a low temperature. On the other hand, when unit N in the polyether glycol exceeds 50 mol %, the glass transition temperature of TPEE (Termoplastic Polyester Elastomer) rises so that properties at a low temperature may be undesirably deteriorated.

A polyether glycol preferably used in the production of a polyether ester block copolymer is produced by charging a plenty amount of neopentyl glycol in the presence of a catalyst showing an activity in the presence of an alcoholic hydroxyl group under the conditions of a high temperature and of a low THF concentration, i.e., a high polymer concentration wherein depolymerization of pure tetramethylene glycol proceeds. As a catalyst showing an activity in the presence of an alcoholic hydroxyl group, a heteropolyacid described in JP-A-60-20366 and a salt of a heteropolyacid described in JP-A-61-120830 can be used. In a case where such a catalyst is used, the requirement wherein a molar ratio of water or a diol to the catalyst is 10 or less is not required in the reaction conditions providing the polyether glycol according to the present invention.

It should be noted that a catalyst showing an activity in the presence of an alcoholic hydroxyl group is not limited particularly to the heteropoly acid, but benzene sulfonic acid and toluene sulfonic acid also can be used as the catalyst. The reason why the copolymerization ratio of neopentyl glycol can be increased in the method under the specific reaction conditions providing the preferred polyether glycol used in the production of the polyether ester block copolymer used in the present invention is that even if the molar ratio of the diol to the catalyst is 30, polymerization can proceed and, therefore, a plenty amount of neopentyl glycol can be charged. Further, the formation of the polymer molecular chain solely consisting of THF is suppressed because the polymerization proceeds under the depolymerization conditions of pure poly(tetramethyleneoxy)glycol.

Essential requirements for preferably producing a polyether glycol used in a polyether ester block copolymer are summarized to the following three requirements: First, use of a catalyst showing an activity in the presence of an alcoholic hydroxyl group, for example, heteropoly acid or sulfonic acid; second, use of a glycol as a copolymerizing glycol which inhibits the spreading of depolymerization, namely use of NPG; and third, a reaction is effected at a temperature and a polymer concentration at which depolymerization of pure PTG proceeds so that polycondensation providing a high copolymerization ratio may be a main reaction.

For the purpose of proceeding of this polycondensation reaction at a desirable rate, as a reaction temperature, 70° C. or more, preferably 75° C. or more is employed. However, if a reaction temperature is too high, a reaction liquid or a catalyst is undesirably highly colored. For example, when phosphotungstic acid is used as a catalyst, generally, a reaction temperature over 110° C. results in severe coloring.

In the foregoing description, catalysts used in the present invention are mentioned. Among these catalysts, preferred catalysts are commercially available and, for example, phosphotungstic acid which is stable at a high temperature and has a high reactivity can be mentioned. In a case where a heteropoly acid such as phosphotungstic acid is used as a catalyst, with proceeding of a reaction, the reaction liquid is separated into a catalyst layer having a high catalyst concentration and a liquid layer having a low catalyst concentration of 1% or less, so that the reaction proceeds in a dispersion state of two layers. After the completion of the reaction, stirring is stopped and the reaction mixture is allowed to stand, which results in the separation of a heavy catalyst layer as the lower layer and a light liquid layer as the upper layer. The upper liquid layer is taken out, and THF, oligomers and dissolved catalyst are removed to obtain the object polymer. NPG and THF are newly supplied to the remaining lower catalyst layer and a new batch reaction is initiated. According to such a procedure, the catalyst is used repeatedly to be able to obtain the polyether ester block copolymer to be used as a raw material of the present invention can be obtained.

In a case where sulfonic acid is used as a catalyst, a catalyst such as Naphion insoluble in a reaction liquid is preferably because the catalyst can be readily separated. It is appropriate that NPG is charged in an amount of 2 to 10 mol per one equivalent of a catalyst such as phosphotungstic acid or sulfonic acid. When NPG is charged in a small amount, an amount of a polymer to be taken out at a time of the completion of the reaction is decreased. Contrary to this, when NPG is charged in a large amount, polycondensation reaction proceeds at a slow speed so that a tong time is required to increase the polymerization degree of a polymer.

Water generated by polycondensation can be taken out as the vapor phase water in a reaction system and removed. The vapor phase mainly consists of THF and generally comprises 0.4 to 2.0 wt % of water. Therefore, in removing water, THF is to be removed together, so THF must be newly supplemented to compensate the loss. Since a vapor phase in a reaction system must be taken out as described above, a reaction liquid has a boiling temperature. For controlling a boiling temperature, i.e., a reaction temperature to a given temperature, it is an easy method to control a THF concentration. Specifically, the control of replenishing rate of THF so at to maintain a liquid temperature to a given temperature can respond to THF taken out together with vapor phase water, a change in a composition with proceeding of a reaction and consumption of THF by polymerization. Namely, according to such a control, basic procedures to be able to respond to the above-described all changes are to be determined for THF.

The THF concentration in a reaction liquid varies depending upon a reaction pressure and a reaction temperature, namely, a boiling pressure and temperature. Accordingly, the THF concentration can be controlled by a reaction pressure with making a reaction temperature condition. A water concentration in a reaction liquid resides in a dynamic equilibrium with a water concentration of a vapor phase in a reaction system. Therefore, the water concentration in the reaction liquid can be controlled by the water concentration of the vapor phase in the reaction system.

A polyether glycol used in the production of a polyether ester block copolymer has a number average molecular weight of 400 to 6,000, preferably 800 to 3000, and more preferably 1,000 to 2,000. If the number average molecular weight is less than 400, generally, a short chain polyester (hard segment) has a short average chain length, although the average chain length depends upon a ratio of a hard/soft segment of a polymerized polyether ester block copolymer finally obtained, so that the polyether ester block copolymer obtained has a noticeably decreased melting point, i.e., has a poor thermal resistance. Therefore, both a case where the polyether ester block copolymer is used as it is as a material and a case where it is used by forming to a composition are not desirable. On the other hand, when it exceeds 6,000, a terminal group concentration in the polyether glycol per a unit weight thereof becomes low so that the polymerization is undesirably difficult to proceed.

The amount of total polyether glycol units (soft segments) in the polyether ester block copolymer used in the present invention is 20 to 90% by weight, preferably 30 to 80% by weight, and more preferably 40 to 70% by weight. The amount of the polyether glycol units in this case is the weight ratio of the soft segment and is not the weight ratio of the charged polyether glycol to the total monomers.

Generally, a hard segment of a polyether ester block copolymer comprises a short chain ester, whereas a soft segment of the same consists of a long chain ester. The terminal of the polyether part is connected with a dicarboxylic acid component through an ester bond to connect with the hard segment. For the convenience' sake, the soft segment is regarded as also including the unit constituting an ester bond at one terminal of the polyether part.

The ratio of the hard/soft segment can be quantitatively determined by 1H-NMR. When the amount of the soft segment is less than 20% by weight, the resulting copolymer is to have a poor flexibility, particularly soft feeling of a steering of the present invention is undesirably lost. On the other hand, when it exceeds 90% by weight, the resulting product is so soft that it is undesirably poor in follow-up property with a metal core.

Such a polyether ester block copolymer can be produced according to a known method. For example, mention may be made of a method wherein a lower alcohol diester of a dicarboxylic acid, an excessive amount of a low molecular glycol and a polyether glycol are subjected to an ester exchange reaction in the presence of a catalyst, then the resulting reaction product is subjected to polycondensation under a reduced pressure; a method wherein a dicarboxylic acid, a glycol and a polyether glycol are subjected to an esterification in the presence of a catalyst, then the resulting reaction product is subjected to polycondensation; and a method wherein a short chain polyester (e.g., polybutylene terephthalate) is previously prepared, then another dicarboxylic acid, diol or polyether glycol is added thereto, or another copolymer polyester is added thereto to cause an ester exchange reaction, whereby randomization may be achieved.

As a catalyst which can be used both in an ester exchange reaction or an esterification and in a polycondensation reacition, which are used in the production of a polyether ester block copolymer, preferably mention may be made of titanium-based catalysts such as tetraalkyl titanates typically represented by tetra(isopropoxy)titanate and tetra(n-butoxy)titanate; reaction products of these tetraalkyl titanates and alkylne glycols; partially hydrolyzed products of tetraalkyl titanates; metal salts of titanium hexaalkoxide; carboxylates of titanium; and titanyl compounds. Further, also can be used monoalkyl tin compounds such as mono n-butylmonohydroxytin oxide, mono n-butyltin triacetate, mono n-butyltin monooctylate and mono n-butyltin monoacetate; and dialkyl (or diallyl) tin compounds such as di n-butyltin oxide, di n-butyltin diacetate, diphenyltin oxide, diphenyltin diacetate and di n-butyltin dioctylate.

In addition to these compounds, metals such as Mg, Pb, Zr and Zn, the metal oxides and the metal salt catalysts are useful. These catalysts can be used alone or in any mixture thereof.

The addition amount of an esterification catalyst or a polycondensation catalyst is preferably 0.005 to 0.5% by weight, particularly preferably 0.03 to 0.2% by weight based on the amount of the resulting polymer. After adding these catalysts at a time of the initiation of an ester exchange reaction or an esterification, it can be added or not added to the reaction system during a polycondensation.

As a part of a dicarboxylic acid or a glycol, polycarboxylic acids, polyfunctional hydroxy compounds or oxy acids can be copolymerized. The polyfunctional components effectively function as a component providing a high viscosity, and can be copolymerized in an amount of 3 mol % or less. As a compound can be used as such a poxlyfunctional components, mention may be made of trimellitic acid, trimesic acid, pyromellitic acid, benzophenone tetracarboxylic acid, butanetetracarboxylic acid, glycerol, pentaerythritol, and esters and acid anhydrides thereof.

Further, depending upon a necessity, a polyether glycol can be partially substituted with another polyether glycol. As the polyether glycol to be used for such a substitution, mention may be made of poly(ethyleneoxy)glycol, poly(propyleneoxy)glycol, poly(tetramethyleneoxy)glycol, poly(1,2-propyleneoxy)glycol, a block or a random copolymer of ethylene oxide and propylene oxide, a random copolymer of THF and 3-methyl THF, a block or a random copolymer of ethylene oxide and THF, poly(2-methyl-1,3-propyleneoxy)glycol and poly(propyleneoxy)diimide diacid.

The number average molecular weight of the polyether glycol used in this substitution is preferably 400 to 6,000, particularly preferably 1,000 to 3,000. As a preferred polyether glycol to be used for substitution, poly(tetramethyleneoxy)glycol can be mentioned. In a case where poly(tetramethyleneoxy)glycol is used for substitution, when a number average molecular weight (Mn) exceeds 1,800, depending upon a molecular weight distribution (Mv/Mn: Mn is a number average molecular weight determined by a terminal hydroxyl valence, Mv is a viscosity average molecular weight defined by the formula; Mv=anti log(0.493 log η+3.0646), provided that η is a melt viscosity at 40° C. shown in terms of poise), crystallization may occur, which sometimes results in the provision of undesirable results for properties at a low temperature.

The polyether glycol for substitution preferably has a molecular weight distribution (Mv/Mn) of 1.6 or less, more preferably, 1.5 or less, i.e. narrow molecular weight distribution. Preferably, the polyether glycol for substitution is used in an amount of 90% by weight or less of the polyether glycol used in the present invention. If this value exceeds 90% by weight, generally, physical properties such as water resistance and properties at a low temperature sometimes cannot be obtained at a satisfactory level, although such physical properties may be affected by a content of neopentyloxide units in the polyether glycol used in the present invention, and, therefore, the amount of the polyether glycol must be determined corresponding to an object of use.

The polymerization degree of the polyether ester block copolymer thus polymerized is generally represented in terms of a relative solution viscosity (η rel), an inherent viscosity ([η]) and a melt flow rate (MFR). In the present invention, a polymerization degree is represented in terms of a melt flow rate (230° C., value under the load of 2.16 kg, hereinafter abbreviated as MFR).

The MFR thereof is 0.5 to 100 g/10 min., preferably 5 to 50 g/10 min., and more preferably 10 to 30 g/min. When MFR is less than 0.5 g/10 min., an injection moldability of the copolymer is undesirably poor to cause short shot. On the other hand, when it exceeds 100 g/10 min., the resulting product undesirably has poor mechanical properties such as breaking strength and elongation at break, abrasion resistance, and compressive strain (C-Set).

The modified olefin resin having an epoxy group or its derivative in the molecule, i.e., component (B) of the present invention exhibits its effect as a compatibilizing agent for compatibilize the polyether ester block copolymer (component (A)) with the rubbery elastomer (component (C)) so that dispersibility of respective components of the resulting thermoplastic elastomer composition may be improved. As the result, not only are improved scratch resistance of the resulting thermoplastic composition and the appearance of a molded product, but also can be obtained a molded product free from peeling. Particularly, it is preferred to form a fine sea-island structure wherein the flexible rubbery elastomer of component (C) having a poor oil resistance is enclosed with a continuous layer of the polyether ester block copolymer by reacting an epoxy group with the polyether ester block copolymer tough and excellent in oil resistance, to provide a thermoplastic elastomer composition having an improved toughness and further excellent oil resistance. In the above-described sea-island structure, the average particle size of component (C) is preferably not larger than 1.4 μm. That is, although the thermoplastic polyester elastomer composition of the present invention may, as one embodiment, have a sea-sea structure wherein both of components (A) and (C) form continuous layers, it is more preferred that the composition has a sea-island structure wherein component (A) constitutes a continuous layer forming sea portion(s) and component (C) is dispersed therein with an average particle size of not larger than 1.4 μm to form island portions. This preferred sea-island structure provides further improved mechanical properties, abrasion resistance and oil resistance.

The modified olefin resin used as component (B) of the present invention is one wherein a molecular unit having en epoxy group or its derivative group is bonded with various olefin resins.

Examples of various kinds of polyolefin resins prior to being subjected to modification, which is to be used as component (B), include polyethylene resin and polypropylene resin. As the polyethylene resin, mention may be made of a low-density polyethylene, a straight chain low-density polyethylene, a high-density polyethylene and a copolymer of ethylene and an α-olefin having 3 to 8 carbon atoms. In the copolymer of ethylene and an α-olefin having 3 to 8 carbon atoms, as the α-olefin in the copolymer, propylene, butene-1, isobutene, pentene-1, hexene-1,4-methylpentene-1, octene-1 can be mentioned. Further the copolymer having less than 20% by weight of the α-olefin can be used.

As the polypropylene resin, a propylene homopolymers or a copolymer of propylene and an α-olefin having 2 to 8 carbon atoms (hereinafter abbreviated as propylene-based resin) can be mentioned. In the copolymer of propylene and an α-olefin having 2 to 8 carbon atoms, as the α-olefin in the copolymer, ethylene, butene-1, isobutene, pentene-1, hexene-1,4-methylpentene-1, octene-1 can be mentioned. Further the copolymer having less than 20% by weight of the α-olefin can be used.

As the example of other polyolefin resins, mention may be made of copolymers of ethylene and organic acid esters such as ethylene-methyl acrylate copolymer (EMA), ethylene-acrylic acid copolymer (EAA), ethylene-vinyl acetate copolymer (EVA), etylene-ethyl acrylate copolymer (EEA); polybutene, poly-4-methyl-pentene-1, novoltene resin, polycyclohexadiene or the hydrogenated products thereof. Among these resins, particularly, a polyethylene resin is preferred because it can provide an elastomer composition excellent in strength and oil resistance.

The epoxy-modified olefin resin of the present invention can be produced by a method wherein ethylene and an epoxy compound having an unsaturated double bond such as glycidyl methacrylate are copolymerized; a method wherein an epoxy compound having an unsaturated double bond such as glycidyl methacrylate is added to an unmodified olefin resin; and a method wherein peracetic acid is reacted with remaining unsaturated bonds.

As an example of a production method of the epoxy-modified olefin resin of the present invention, mention may be made of a method, wherein an olefinic monomer and a compound comprising an epoxy group or its derivative group are copolymerized using a usually used radical initiator or Ziegler catalyst. Alternatively, by making a compound comprising an epoxy group or its derivative group and a usually used radical initiator be coexistent, whereby the compound comprising an epoxy group or its derivative group is added to the above-described olefin resin by the function of a radical.

As a production method wherein a compound comprising an epoxy group or its derivative group is added to an olefin resin by the function of a radical, mention may be made a method comprising reacting an unmodified olefin resin with an epoxy group or its derivative group in the coexistence of a radical initiator in the presence of an inert gas in an extruder. Further can be used a method comprising dissolving an unmodified olefin resin in a solvent such as toluene or xylene, then reacting the resulting solution with an epoxy group or its derivative group in the presence of a radical initiator. Unreacted epoxy group or its derivative is preferably eliminated by an appropriate post-treatment such as vacuum deaeration, extraction or precipitation.

The content of a compound comprising an epoxy group or its derivative group in a polymer is 0.1 to 20 parts by weight, preferably 3 to 15 parts by weight, and more preferably 8 to 12 parts by weight. When the amount of the epoxy group or its derivative group is too large, such problems may arise that the resulting composition is to have a decreased flowability and a worsened moldability. On the other hand, when the amount of the epoxy group or its derivative group is too small, an improvement effect in compatibility between component (A) and component (C) of the present invention is insufficient. Thus, the above-described amount range is desirable.

The amount of component (B) of the present invention is 3 to 100 parts by weight, preferably 5 to 30 parts by weight, and more preferably 8 to 20 parts by weight per 100 parts by weight of component (A) of the present invention. When the amount of component (B) is less than 3 parts by weight, sufficient improvement effect in compatibility cannot be obtained and a composition excellent in strength, scratch resistance, appearance and oil resistance cannot be obtained. On the other hand, even if it is used in a large amount, over 100 parts by weight, an improvement effect in compatibility cannot be increased any more. On the contrary, the decrease in flowability becomes noticeable and, further, the resulting composition obtained undesirably is not to be excellent in strength, scratch resistance, appearance and oil resistance.

As the rubbery elastomer of component (C) of the present invention, mention may be made of olefinic elastomers, e.g., ethylene-α-olefin copolymers (the ratio of α-olefin is 20% by weight or more) such as ethylene-propylene copolymer, ethylene-propylene-5-ethylidene norbornene copolymer, ethylene-propylene-5-methyl norbornene copolymer, ethylene-propylene-dicyclopentadiene copolymer, ethylene-butene copolymer and ethylene-octene copolymer, and compositions of these elastomers and the above-described olefinic resins (including dynamic valcanizates); and styrene-based elastomers such as styrene-butadiene block copolymer, styrene-isoprene block copolymer and the hydrogenated products thereof. Further, as a rubbery elastomer of component (C) of the present invention, also can be used diene-based elastomers such as polybutadiene, polyisoprene and random copolymers of polybutadiene and polystyrene, and hydrogenated products thereof; natural rubber; gum balata; acryl rubber; chloroprene rubber; silicone rubber; nitrile rubber; fluorine rubber; and urethane rubber. Among these elastomers, particularly, olefin-based elastomers and styrene-based elastomers are preferred because of being able to provide an elastomer composition-having excellent moldability, rubber elasticity and scratch resistance. Particularly preferably, when an olefinic elastomer of an ethylene-α-olefin copolymer having 20% by weight or more of an α-olefin, and a styrene-based elastomer obtained by hydrogenating a styrene-diene block copolymer are used as component (C) of the present invention, can be obtained a thermoplastic composition having further excellent strength and oil resistance.

As commercially available products of the above-described olefinic elastomer, “Thermorun” produced by Mitsubishi Kagaku K.K., “Milastomer” produced by Mitsui Sekiyukagaku Kogyo K.K. (Mitsui Petroleum Chemical Industry K.K.), “Sumitomo TPE” produced by Sumitomo Kagaku K.K., “Santoprene” produced by AES K.K., “Engage” produced by Daw Chemical K.K. can be mentioned. As commercially available products of the above-described styrene-based elastomer, “Tuftec” produced by Asahi Kasei Kogyo K.K., “Rabalon” produced by Mitsubishi Kagaku K.K., “Kraton G” produced by Shell Japan K.K., “Septon” and “Hybrar” produced by Kraray, and “Dynaron” produced by Nippon Gosei gomu K.K. (Japan Synthetic Rubber) can be mentioned.

To the elastomer composition of the present invention, the above-described polyolefin-based resin can be added as needed.

Further, a plasticizer can be added as needed to the elasomer composition of the present invention. Examples of such a plasticizer include phthalates such as dioctyl phthalate, dibutyl phthalate, diethyl phthalate, butyl benzyl phthalate, di-2-ethylhexyl phthalate, diisodecyl phthalate, diundecyl phthalate and diisononyl phthalate; phosphates such as tricresyl phosphate, triethyl phosphate, tributyl phosphate, tri-2-ethylhexyl phosphate, trimetylhexyl phosphate, tris-chloroethyl phosphate and trs-dichloropropyl phosphate; aliphatic esters such as octyl trimellitate, isodecyl trimellitate, trimellitates, dipentaerythritol esters, dioctyl adipate, dimethyl adipate, di-2-ethylhexyl azelate, dioctyl azelate, dioctyl sebacate, di-2-ethylhexyl sebacate and methylacetyl ricinocate; pyromellitates such as octyl pyromellitate; epoxy plasticizers such as epoxidized soybean oil, epoxidized linseed oil and epoxidized aliphatic alkyl esters; polyether plasticizers such as adipic acid ether ester and polyether; liquid rubber such as liqid NBR, liquid acrylic rubber and liquid polybutadiene; and non-aromatic paraffinic oils.

These plasticizers can be used alone or in any mixture thereof. The addition amount of the plasticizer is appropriately selected corresponding to a required hardness or a physical property. However, it is preferably used in an amount of 0 to 50 parts by weight per 100 parts by weight of a composition.

To the present elastomer composition can be added an inorganic filler, a stabilizer, a lubricant, a colorant, silicone oil, a foaming agent and a flame retardant. As the inorganic filler, for example, mention may be made of calcium carbonate, talc, magnesium hydroxide, mica, barium sulfate, silicic acid (white carbon), titanium oxide and carbon black. As the stabilizer, mention may be made of a hindered phenol-based antioxidant; a phosphorus-based heat stabilizer, a hindered amine-based photo stabilizer and a benzotriazole-based UV absorber. As the lubricant, mention may be made of stearic acid, stearates, metal salts of stearic acid.

Generally, as a method for producing the elastomer composition of the present invention, can be used any method known in the conventional art for blending a polymer component. In order to obtain the most uniform blend, preferred is a method wherein usually used various mixing machines such as a mixing roll, a kneader, a Banbury mixer and an extruder are used to effect melt-kneading. Prior to effecting melt-kneading, these compounded products are dry-blended using a mixer such as a Henschel mixer, a tumbler or a ribbon mixer, then, the mixture obtained is melt-kneaded, whereby a uniform elastomer composition can be obtained.

As a fabrication method of the elastomer composition of the present invention, injection molding, extrusion molding, compression molding can be applied. However, particularly, the injection molding has such a property that moldability during the molding is excellent. In a case where the injection molding is effected, a usual molding machine for plastic can be employed and an injection molded product can be obtained in a short time. Further, since the elastomer composition of the present invention is excellent in thermal stability so that a sprue part or a runner part can be advantageously recycled.

### EXAMPLES

The present invention will be illustrated in greater detail with reference to the following Examples and Comparative Examples, but the invention should not be construed as being limited thereto.

In the Examples and Comparative Examples, test methods used in various evaluation methods are as follows:

(1) Shore D hardness [-]:

Determined according to ASTM D2240, type D, at 23° C.

(2) Melt flow rate (MFR) [g/10 min]:

Determined according to ASTM D1238, at 230° C. under the load of 2.16 kg

(3) Tensile strength [kgf/cm²]:

JIS K6251 No.3 dumbbell and as a sample, a press sheet having a thickness of 2 mm were used.

(4) Elongation [%]:

JIS K6251 No.3 dumbbell and as a sample, a press sheet having a thickness of 2 mm were used.

(5) Impact resilience [%]:

JIS K6255, Lüpke swing type, at 23° C.

(6) Brittle temperature [0° C.]:

JIS K6261 Gehman torsional test, at 100° C.

(7) Scratch resistance, gloss retention rate [%]:

A flat plate having a smooth surface was molded by injection molding. The flat plate was placed horizontally, and a cotton fabric was put thereon to which a load 40 g/cm² was applied. The cotton fabric was reciprocated 200 times on the plate. From the gloss of the abraded surface determined by the method according to JIS K7105 (E1) and the gloss before rubbing (E0), a retention rate (E1/E0)×100 (%) was calculated.

(8) Emboss disappearance test:

A flat plate having emboss on its surface (satin-finished, depth of etching is about 20 micron) was molded by injection molding. The flat plate obtained was allowed to stand in an oven having a temperature of 100° C. for 168 hours. After taking the flat plate from the oven, the surface state was observed visually. The evaluation criteria are as follows:

∘ . . . no change,

Δ . . . some gloss is observed,

× . . . gloss is observed

(9) Moldability:

A flat plate having a length of 150 mm, a width of 100 mm and a thickness of 2 mm was molded by means of an injection molding machine under the following conditions (Gate is a side gate having a section of 10×2 mm). The appearance of the molded product obtained, i.e., flow mark and gloss, was visually observed. The evaluation criteria are as follows:

∘ . . . good,

Δ . . . rather poor,

× . . . poor

Cylinder temperature:

C1: 200° C., C2: 210° C., C3: 210° C.

Nozzle temperature: 200° C.

Injection speed: low

Mold temperature: 40° C.

(10) Evaluation of release properties:

A flat plate was molded under the above-described injection conditions except that the injection speed was high, By visual observation, a product showing a peeling phenomenon-in a gate portion is regarded as poor, and a product showing no peeling phenomenon is regarded as good.

(11) Evaluation of oil resistance:

As a sample, a press sheet having a thickness of 2 mm was used. The sample was immersed in JIS No. 3 swelling oil at 70° C. for 168 hours and the presence or absence of eluation of component (C) and the degree of the eluation was classified into three ranks, i.e., non, micro amount and plenty amount.

(12) Evaluation of dispersion state of component (C):

As a sample, a press sheet having a thickness of 2 mm was used. The sample was freezing-cut at −100° C. or less and immersed in cyclohexane for 16 hours so that component (C) was eluted. Thereafter, the rupture cross-section was subjected to gold-deposition and the dispersion state of component (C) in component (A) was observed by a scanning type electron microscope. In a case where a sea-island structure having an island structure of component (C) is recognized, an average particle diameter of the island was determined.

Respective components used in Examples and Comparative Examples are as follows.

Component (A): Polyether Ester Block Copolymer

In the below-described component (A)-1 to 3, as a polyoxyalkylene glycol used as a soft segment of a polyether ester block copolymer, the following glycols were used.

(1) Poly(tetramethyleneoxy)glycol copolymerized with neopengtyl glycol (copolymer comprising T and N, and having alcoholic hydroxyl groups at both terminals): produced by Asahi Kasei Kogyo Co., Ltd., Mn=1480, Mv/Mn=1.73, N content=12 mol %

(2) poly(tetramethyleneoxy)glycol: produced by Hodogaya Kagaku Co., Ltd., PTG-1,800, Mn=1828, Mv/Mn=2.11

Component (A)-1:

To a conical reactor (VCR) having a capacity of 15 liter (produced by Mitsubishi Jyukogyo Co., Ltd.) 1520 g of dimethylphthalate (produced by Mitsubishi Kasei Co., Ltd., the same in the following description, 1060 g of 1,4-butane diol (produced by Wako Junyaku Co., Ltd., guaranteed reagent, the same in the following description) 3200 g of the above-described (1) polyoxyalkylene glycol and 15 g of Irganox (produced by Chiba Geigy K.K.) were charged, the resulting mixture was subjected to nitrogen-substitution and heated to 200° C. in a nitrogen atmosphere. Successively, 1.5 g of tetraisopropoxy titanate (produced by Tokyo Kasei, highest quality reagent, the same in the following description) was added and the resulting mixture was kept at 200° C. for 30 minutes and further heated to 230° C. The mixture obtained was then subjected to an ester exchange reaction with stirring at a velocity of 150 rpm for 2 hours. The amount of the distilled methanol was 94% of the theoretical amount. Successively, the reaction mixture was heated to 250° C. and vacuumed to 0.5 mmHg for 30 minutes with stirring at a velocity of 50 rpm. Thereafter, the resulting mixture was subjected to condensation for about 3 hours until torque is not enhanced any more.

The content of the reactor was taken out from the lower part of the same. Thus, a polyether ester block copolymer was obtained as a transparent viscous polymer. The polymer obtained was subjecting to strand-cutting to form pellets and vacuum-dried at 700C for 12 hours. With this pellets 100 parts by weight, were melt-blended 1 part by weight of carbon black master pellets (Royal black RB 9005), 0.1 parts by weight of Irganox 1010, 0.15 parts by weight of dilauryl thiopropoonate (DLPT, produced by Yoshitomi Seiyaka (pharmacy) Co.,Ltd.) and 0.1 parts by weight of TINUVIN327 (produced by Chiba Geigy) at 230° C. in an extruder. Thus, a thermoplastic polyester elastomer could be obtained.

This thermoplastic polyester elastomer had Shore D hardness of 32 and MFR of 23 g/10 min.

Component (A)-2:

An ester exchange reaction and a condensation reaction were effected as in the synthesis of (A)-1 except that the charge amount of dimethylterephthalate was changed to 2070 g, the charge amount of 1,4-butane diol was changed to 1440 g and the charge amount of the polyoxyalkylene glycol (1) was changed to 2750 g. The kind of the additive and the formulation ratio were the same as in (A)-1. The thermoplastic polyester elastomer obtained had Shore D hardness of 40 and MFR of 21 g/10 min.

Component (A)-4:

Pelprene P-40B produced by Toyobouseki Co., Ltd., which is a polyether ester block copolymer wherein a hard segment comprises polybutyrene terephthalate and a soft segment comprises a polytetramethylene glycol having a molecular weight of about 2000, and the weight ratio of the soft segment is about 70% by weight.

Component (A)-5:

Pelprene P-40H produced by Toyobouseki Co., Ltd., which is a polyether ester block copolymer wherein a hard segment comprises polybutyrene terephthalate and a soft segment comprises a polytetramethylene glycol having a molecular weight of about 1000, and the weight ratio of the soft segment is about 70% by weight.

Component (B): Modified Polymer

Component (3)-1:

A block copolymer of a hydrogenated styrene/butadiene block copolymer having a number-average molecular weight of 55,000, a molecular weight distribution of 1.08, a bonded styrene content of 20% by weight, a 1,2-vinyl-bonded amount of polybutadiene part prior to hydrogenation of 35% by weight and a hydrogenation rate of the polybutadiene part of 99% was synthesized according to the method described in JP-A-60-220147, and glycidyl methacrylate was added to the hydrogenated block copolymer in an amount of 2% by weight in an extruder.

Component (B)-2:

An epoxy-modified polyethylene (produced by Sumitomo Kagaku Co., Ltd., Bondfast E, glycidylmethacrylate 12% by weight-copolymerized polyethylene, MFR: 3 g/10 min.).

Component (B)-3:

An epoxy-modified polyethylene-vinyl acetate copolymer (produced by Sumitomo Kagaku Co., Ltd., Bondfast 7B, glycidylmethacrylate 12% by weight and vinyl acetate 5% by weight-copolymerized polyethylene, MFR: 7 g/10 min.).

Component (B)-4:

A polymethyl methacrylate grafted product of an epoxy-modified polyethylene copolymer (produced by Nippon yushi (Japan Fats and Oils) Co., Ltd., Modiper A 4200, product obtained by graft-polymerizing 43 parts by weight of methyl methacrylate to 100 parts by weight of glycidyl methacrylate 15% by weight-copolymerized polyethylene, MFR: 0.6 g/10 min.).

Component (B)-5:

A polybutyl acrylate-methyl methacrylate copolymer-grafted product of an epoxy-modified polyethylene copolymer (produced by Nippon yushi (Japan Fats and Oils) Co., Ltd., Modiper A 4300, product obtained by graft-polymerizing 43 parts by weight of polybutyl acrylate and methyl methacrylate to 100 parts by weight of glycidyl methacrylate 15% by weight-copolymerized polyethylene).

Component (B)-6:

Maleic acid-modified polyethylene (produced by Sumitomo Kagaku Co., Ltd., Bondine Ax8390, maleic anhydride 32% by weight-copolymerized polyethylene, MFR: 7 g/10 min.).

Component (B)-7:

An ethylene-ethyl acrylate copolymer having polybutyl acrylate-methyl methacrylate copolymer grafted thereon (produced by Nippon yushi (Japan Fats and Oils) Co., Ltd., Modiper A 5300, product obtained by graft-polymerizing 43 parts by weight of polybutyl acrylate and methyl methacrylate to 100 parts by weight of ethyl acrylate 20% by weight-copolymerized polyethylene).

Component (B)-8:

A maleic acid-modified hydrogenated styrene butadiene block copolymer (produced by Asahi Kasei Kogyo Co.,Ltd., Tuftec M1943, maleic anhydride 2% by weight gafted-hydrogenated styrene butadiene block copolymer).

Component (C): Rubbery Elastomer

Component (C)-1

A block copolymer of a hydrogenated styrene/butadiene block copolymer having a number-average molecular weight of 75,000, a molecular weight distribution of 1.10, a bonded styrene content of 20% by weight, a 1,2-vinyl-bonded amount of polybutadiene part prior to hydrogenation of 38% by weight and a hydrogenation rate of the polybutadiene part of 99% was synthetized according to the method described in JP-A-60-220147.

Component (C)-2:

A block copolymer of a hydrogenated styrene/butadiene block copolymer having a number-average molecular weight of 150,000, a molecular weight distribution of 1.20, a bonded styrene content of 32% by weight, a 1,2-vinyl-bonded amount of polybutadiene part prior to hydrogenation of 38% by weight and a hydrogenation rate of the polybutadiene part of 99% was synthetized according to the method described in JP-A-60-220147.

Component (C)-3:

Ethylene-butene copolymer (produced by Mitsui Sekiyukagaku Kogyo K.K. (Mitsui petroleum chemical industry K.K.), Tafmer P-0280, MFR; 5.0, density; 0.88)

Component (C)-4:

A polyolefin-based elastomer consisting of ethylene-propylene copolymer and polypropylene (produced by Mitsubishi Kagaku Co., Ltd., Thermorun 3601, density; 0.88, JIS A hardness (JIS K6301); 70)

Component (C)-5:

A block copolymer of a hydrogenated styrene/butadiene block copolymer having a number-average molecular weight of 120,000, a molecular weight distribution of 1.20, a bonded styrene content of 35% by weight, a 1,2-vinyl-bonded amount of polybutadiene part prior to hydrogenation of 35% by weight and a hydrogenation rate of the polybutadiene part of 99% was synthetized according to the method described in JP-A-60-220147.

### Examples 1 to 11

As a polyether ester block copolymer, (A)-1 and (A)-2, as a modified polymer, (B)-1 and (B)-2, and as a rubbery elastomer, (C)-1, (C)-2, (C)-3 and (C)-4 were used. They were blended in respective proportions shown in Tables 1, 2 and 3 by means of a Henschel mixer. Thereafter, the resulting blend was melt-kneaded in a same direction biaxial extruder having a diameter of 45 mm at 220° C. to obtain pellets of an elastomer composition. Results of physical properties and fabrication properties are shown in Tables 1, 2 and 3.

### Comparative Examples 1 to 4

As a polyether ester block copolymer, (A)-1 and (A)-3, as a modified polymer, (B)-1, and as a rubbery elastomer, (C)-1 were used. They were blended in respective proportions shown in Table 4 according to the same manner as that of Example 1 and evaluated. The results are shown in Table 4. From this result, it is apparent that a composition which is not covered by the present invention is poor in some of the physical properties.

### Examples 12 to 14

As a polyether ester block copolymer, (A)-1, as a modified polymer, (B)-1, and as a rubbery elastomer,. (C)-2 were used. Further, polypropylene (produced by Nippon (Japan) Polyolefin Co., Ltd., block type PP, MK711, MFR; 30) and a hydrocarbon oil (produced by Idemitsu Kousan Co., Ltd., Diana process oil PW380) were used. They were blended in respective proportions shown in Table 5 by means of a Henschel mixer. Thereafter, the resulting blend was melt-kneaded in a same direction biaxial extruder having a diameter of 45 mm at 220° C. to obtain pellets of an elastomer composition. Results of physical properties and fabrication properties are shown in Table 5.

### Examples 15 to 29

As a polyether ester block copolymer, (A)-4 and (A)-5, as a modified polymer, (F)-2, (3)-S, (B)-4 and (B)-5 and as a rubbery elastomer, (C)-5 were used. They were blended in respective proportions shown in Tables 6, 7 and % by means of a Henschel mixer. Thereafter, the resulting blend was melt-kneaded in a same direction biaxial extruder having a diameter of 45 mm at 220° C. to obtain pellets of an elastomer composition. Results of physical properties and fabrication properties are shown in Tables 6, 7 and 8.

### Comparative Examples 5 to 9

As a polyether ester block copolymer, (A)-4, as a modified polymer, (B)-6, (B)-7 and (B)-8 and as a rubbery, elastomer, (C)-5 were used. They were blended in respective proportions shown in Table 9 according to the same manner as that of Examples 15 to 29 and evaluated. The results are shown in Table 9. From this result, it is apparent that a composition which is not covered by the present invention is poor in some of the physical properties.

TABLE 1

| | Example 1 | Example 2 | Example 3 | Example 4 |
|---|---|---|---|---|
| Composition | | | | |
| Component (A): polyether ester | (A)-1 | (A)-2 | (A)-1 | (A)-1 |
| block copolymer | 100 | 100 | 100 | 100 |
| Component (B): modified polymer | (B)-1 | (B)-1 | (B)-2 | (B)-1 |
| | 25 | 25 | 25 | 25 |
| Component (C): rubbery elastomer | (C)-1 | (C)-1 | (C)-1 | (C)-2 |
| | 100 | 100 | 100 | 100 |
| Physical property | | | | |
| MFR (g/10 min.) | 13 | 11 | 4 | 6 |
| Hardness (Shore D) | 28 | 32 | 30 | 30 |
| Tensile strength (kgf/cm²) | 250 | 280 | 260 | 300 |
| Elongation (%) | 850 | 800 | 780 | 880 |
| Impact resilience (%) | 66 | 63 | 62 | 58 |
| Scratch resistance | 96 | 97 | 93 | 99 |
| Gloss retention rate (%) | | | | |
| Brittle temperature (° C.) | −54 | −55 | −56 | −56 |
| Emboss disappearance test | ∘ | ∘ | ∘ | ∘ |
| Fabrication property | ∘ | ∘ | Δ | ∘ |
| Evaluation of peeling property | Good | Good | Good | Good |

TABLE 2

| | Example 5 | Example 6 | Example 7 | Example 8 |
|---|---|---|---|---|
| Composition | | | | |
| Component (A): polyether ester | (A)-1 | (A)-1 | (A)-1 | (A)-1 |
| block copolymer | 100 | 100 | 100 | 100 |
| Component (B): modified polymer | (B)-1 | (B)-1 | (B)-1 | (B)-1 |
| | 25 | 25 | 10 | 50 |
| Component (C): rubbery elastomer | (C)-3 | (C)-4 | (C)-1 | (C)-1 |
| | 100 | 100 | 100 | 100 |
| Physical property | | | | |
| MFR (g/10 min.) | 16 | 5 | 16 | 9 |
| Hardness (Shore D) | 30 | 31 | 26 | 30 |
| Tensile strength (kgf/cm²) | 160 | 140 | 200 | 270 |
| Elongation (%) | 650 | 550 | 750 | 830 |
| Impact resilience (%) | 50 | 48 | 60 | 68 |
| Scratch resistance | 87 | 82 | 90 | 98 |
| Gloss retention rate (%) | | | | |
| Brittle temperature (° C.) | −41 | −43 | −55 | −54 |
| Emboss disappearance test | Δ | ∘ | ∘ | ∘ |
| Fabrication property | ∘ | Δ | ∘ | Δ |
| Evaluation of peeling property | Good | Good | Good | Good |

TABLE 3

| | | Example | Example |
|---|---|---|---|
| | Example 9 | 10 | 11 |
| Composition | | | |
| Component (A): polyether ester | (A)-1 | (A)-1 | (A)-1 |
| block copolymer | 100 | 100 | 100 |
| Component (B): modified polymer | (B)-1 | (B)-1 | (B)-1 |
| | 25 | 25 | 25 |
| Component (C): rubbery elastomer | (C)-1 | (C)-1 | (C)-1 |
| | 30 | 200 | 400 |
| Physical property | | | |
| MFR (g/10 min.) | 20 | 7 | 3 |
| Hardness (Shore D) | 30 | 21 | 18 |
| Tensile Strength (kgf/cm²) | 250 | 210 | 190 |
| Elongation (%) | 800 | 950 | 920 |
| Impact resilience (%) | 68 | 63 | 58 |
| Scratch resistance | 98 | 94 | 88 |
| Gloss retention rate (%) | | | |
| Brittle temperature (° C.) | −66 | −48 | −42 |
| Emboss disappearance test | ∘ | ∘ | ∘ |
| Fabrication property | ∘ | ∘ | Δ |
| Evaluation of peeling property | Good | Good | Good |

TABLE 4

| | Comp. | Comp. | Comp. | Comp. |
|---|---|---|---|---|
| | Ex. 1 | Ex. 2 | Ex. 3 | Ex. 4 |
| Composition | | | | |
| Component (A): polyether ester | (A)-1 | (A)-1 | (A)-1 | (A)-1 |
| block copolymer | 100 | 100 | 100 | 100 |
| Component (B): modified polymer | (B)-1 | (B)-1 | (B)-1 | (B)-1 |
| | 0 | 120 | 25 | 25 |
| Component (C): rubbery elastomer | (C)-1 | (C)-1 | (C)-1 | (C)-1 |
| | 100 | 100 | 0 | 950 |
| Physical property | | | | |
| MFR (g/10 min.) | 16 | 1 | 16 | 6 |
| Hardness (Shore D) | 30 | 34 | 35 | 16 |
| Tensile strength (kgf/cm²) | 140 | 240 | 270 | 180 |
| Elongation (%) | 820 | 700 | 800 | 820 |
| Impact resilience (%) | 55 | 63 | 63 | 61 |
| Scratch resistance | 45 | 81 | 98 | 65 |
| Gloss retention rate (%) | | | | |
| Brittle temperature (° C.) | −48 | −52 | −65 | −51 |
| Emboss disappearance test | ∘ | ∘ | ∘ | Δ |
| Fabrication property | x | X | X | ∘ |
| Evaluation of peeling property | Poor | Poor | Good | good |

TABLE 5

| | Example | Example | Example |
|---|---|---|---|
| | 12 | 13 | 14 |
| Composition | | | |
| Component (A): polyether ester | (A)-1 | (A)-1 | (A)-1 |
| block copolymer | 100 | 100 | 100 |
| Component (B): modified polymer | (B)-1 | (B)-1 | (B)-1 |
| | 25 | 25 | 25 |
| Component (C): rubbery elastomer | (C)-2 | (C)-2 | (C)-2 |
| | 100 | 100 | 100 |
| Polypropylene | 30 | 0 | 30 |
| Hydrocarbon oil | 0 | 50 | 50 |
| Physical property | | | |
| MFR (g/10 min.) | 10 | 12 | 16 |
| Hardness (Shore D) | 32 | 25 | 28 |
| Tensile strength (kgf/cm²) | 310 | 270 | 250 |
| Elongation (%) | 770 | 980 | 940 |
| Impact resilience (%) | 55 | 65 | 60 |
| Scratch resistance | 95 | 92 | 90 |
| Gloss retention rate (%) | | | |
| Brittle temperature (° C.) | −52 | −59 | −60 |
| Emboss disappearance test | ∘ | ∘ | ∘ |
| Fabrication property | ∘ | ∘ | ∘ |
| Evaluation of peeling property | Good | Good | Good |

TABLE 6

| | Example | Example | Example | Example | Example |
|---|---|---|---|---|---|
| | 15 | 16 | 17 | 18 | 19 |
| Composition | | | | | |
| Component (A): | (A)-4 | (A)-4 | (A)-4 | (A)-4 | (A)-4 |
| polyether ester | 100 | 100 | 100 | 100 | 100 |
| block copolymer | | | | | |
| Component (B) | (B)-2 | (B)-3 | (B)-4 | (B)-5 | (B)-2 |
| modified polymer | 16 | 16 | 16 | 16 | 22 |
| Component (C): | (C)-5 | (C)-5 | (C)-5 | (C)-5 | (C)-5 |
| rubbery elastomer | 28 | 28 | 28 | 28 | 64 |
| Hydrocarbon oil | 15 | 15 | 15 | 15 | 36 |
| Physical property | | | | | |
| Hardness (Shore D) | 22 | 25 | 22 | 24 | 20 |
| Tensile strength | 132 | 118 | 115 | 126 | 122 |
| (kgf/cm²) | | | | | |
| Elongation (%) | 923 | 844 | 827 | 774 | 879 |
| Oil resistance | none | none | Micro | Micro | Micro |
| Eluation of component | | | amount | amount | amount |
| (C) after immersing | | | | | |
| JIS No.3 oil | | | | | |
| Structure | Sea- | Sea- | Sea- | Sea- | Component |
| Dispersion state of | island | island | island | island | (C) is |
| component (C) | structure | structure | structure | structure | continu- |
| | having | having | having | having | ous layer |
| | island of | island of | island of | island of | |
| | Component | Component | Component | Component | |
| | (C) | (C) | (C) | (C) | |
| Average particle | 0.5 | 0.2 | 1.4 | 0.5 | — |
| diameter of component | | | | | |
| (C) (μm) | | | | | |

TABLE 7

| | Example | Example | Example | Example | Example |
|---|---|---|---|---|---|
| | 20 | 21 | 22 | 23 | 24 |
| Composition | | | | | |
| Component (A): | (A)-4 | (A)-4 | (A)-4 | (A)-4 | (A)-4 |
| polyether ester | 100 | 100 | 100 | 100 | 100 |
| block copolymer | | | | | |
| Component (B): | (B)-5 | (B)-2 | (B)-5 | (B)-2 | (B)-2 |
| modified polymer | 22 | 28 | 28 | 32 | 48 |
| Component (C): | (C)-5 | (C)-5 | (C)-5 | (C)-5 | (C)-5 |
| rubbery elastomer | 64 | 96 | 96 | 28 | 28 |
| Hydrocarbon oil | 36 | 54 | 54 | 15 | 15 |
| Physical property | | | | | |
| Hardness (Shore D) | 19 | 19 | 16 | 25 | 30 |
| Tensile strength | 86 | 118 | 81 | 118 | 115 |
| (kgf/cm²) | | | | | |
| Elongation (%) | 748 | 857 | 763 | 827 | 764 |
| Oil resistance | Micro | Micro | Micro | None | None |
| Eluation of | amount | amount | amount | | |
| component (C) | | | | | |
| after immersing | | | | | |
| JIS No.3 oil | | | | | |
| Structure | | | | | |
| Dispersion state | Component | Component | Component | Sea- | Sea- |
| of component (C) | (C) is | (C) is | (C) is | island | island |
| | continu- | continu- | continu- | structure | structure |
| | ous layer | ous layer | ous layer | having | having |
| | | | | island of | island of |
| | | | | Component | Component |
| | | | | (C) | (C) |
| Average particle | — | — | — | 0.2 | 0.5 |
| diameter of | | | | | |
| component | | | | | |
| (C) (μm) | | | | | |

TABLE 8

| | Example | Example | Example | Example | Example |
|---|---|---|---|---|---|
| | 25 | 26 | 27 | 28 | 29 |
| Composition | | | | | |
| Component (A): | (A)-4 | (A)-4 | (A)-5 | (A)-5 | (A)-5 |
| polyether ester | 100 | 100 | 100 | 100 | 100 |
| block copolymer | | | | | |
| Component (B): | (B)-5 | (B)-5 | (B)-2 | (B)-4 | (B)-5 |
| modified polymer | 32 | 48 | 16 | 16 | 16 |
| Component (C): | (C)-5 | (C)-5 | (C)-5 | (C)-5 | (C)-5 |
| rubbery elastomer | 28 | 28 | 28 | 28 | 28 |
| Hydrocarbon oil | 15 | 15 | 15 | 15 | 15 |
| Physical property | | | | | |
| Hardness (Shore D) | 25 | 25 | 30 | 31 | 31 |
| Tensile strength | 113 | 113 | 134 | 125 | 118 |
| (kgf/cm²) | | | | | |
| Elongation (%) | 772 | 728 | 808 | 808 | 764 |
| Oil resistance | none | none | None | none | none |
| Eluation of | | | | | |
| component (C) | | | | | |
| after immersing | | | | | |
| JIS No.3 oil | | | | | |
| Structure | | | | | |
| Dispersion state | Sea- | Sea- | Sea- | Sea- | Sea- |
| of component (C) | island | island | island | island | island |
| | structure | structure | structure | structure | structure |
| | having | having | having | having | having |
| | island of | island of | island of | island of | island of |
| | Component | Component | Component | Component | Component |
| | (C) | (C) | (C) | (C) | (C) |
| Average particle | 0.3 | 0.4 | 0.2 | 0.3 | 0.4 |
| diameter of | | | | | |
| component (C) (μm) | | | | | |

TABLE 9

| | Comp. | Comp. | Comp. | Comp. | Comp. |
|---|---|---|---|---|---|
| | Ex. 5 | Ex. 6 | Ex. 7 | Ex. 8 | Ex. 9 |
| Composition | | | | | |
| Component (A): | (A)-4 | (A)-4 | (A)-4 | (A)-4 | (A)-4 |
| polyether ester block | 100 | 100 | 100 | 100 | 100 |
| copolymer | | | | | |
| Component (B): | (B)-2 | (B)-6 | (B)-7 | (B)-8 | (B)-8 |
| modified polymer | 0 | 16 | 16 | 16 | 25 |
| Component (C): | (C)-5 | (C)-5 | (C)-5 | (C)-5 | (C)-5 |
| rubbery elastomer | 43 | 43 | 43 | 43 | 100 |
| Hydrocarbon oil | 15 | 15 | 15 | 15 | 36 |
| Physical property | | | | | |
| Hardness (Shore D) | 23 | 21 | 23 | 22 | 18 |
| Tensile strength | 75 | 64 | 55 | 72 | 72 |
| (kgf/cm²) | | | | | |
| Elongation (%) | 782 | 704 | 598 | 608 | 818 |
| Oil resistance | | | | | |
| Eluation of component | Plenty | Plenty | Plenty | Plenty | Plenty |
| (C) after immersing | amount | amount | amount | amount | amount |
| JIS No.3 oil | | | | | |
| Structure | Sea- | Component | Component | Sea- | Component |
| Dispersion state of | island | (C) is | (C) is | island | (C) is |
| component (C) | structure | continu- | continu- | structure | continu- |
| | having | ous layer | ous layer | having | ous layer |
| | island of | | | island of | |
| | Component | | | Component | |
| | (C) | | | (C) | |
| Average particle | 2 | — | — | 1.8 | — |
| diameter of component | | | | | |
| (C) (μm) | | | | | |

The elastomer composition obtained according to the present invention is excellent in scratch resistance, strength, thermal resistance, oil resistance, flexibility and fabrication property and, therefore, can be suitably used in various fields such as automobile parts, appliance parts, toys and general merchandises. Particularly, because of excellent in scratch resistance, it can be suitably used in interior parts of automobiles requiring good appearance such as instrument panel, arm rest, handle and horn pad and interior and exterior parts of automobiles such as wind moll and bumper. Further, because of excellent in scratch resistance and moldability on the surface of a molded product, coating process which has been conventionally essential can be saved. Thus, high productivity and low cost can be realized.

While the invention has been described in detail and with reference to specific examples thereof, it will be apparent to one skilled in the art that various changes and modifications can be made therein without departing from the spirit and scope thereof.

What is claimed is:

1. A thermoplastic elastomer composition comprising the following components (A), (B) and (C):
(A) 100 parts by weight of a thermoplastic polyester elastomer;
(B) 3 to 100 parts by weight of a modified olefin resin having an epoxy group or a derivative group thereof in its molecule; and
(C) 10 to 900 parts by weight of a rubbery elastomer selected from the group consisting of an olefin-based thermoplastic elastomers and styrene-based thermoplastic elastomers.

2. The thermoplastic elastomer composition according to claim 1, wherein the modified olefinic resin is an olefinic resin copolymerized or grafted with glycidyl methacrylate.

3. The thermoplastic elastomer composition according to claim 1, wherein the styrene-based thermoplastic elastomer is a hydrogenated styrene-based thermoplastic elastomer.

4. The thermoplastic elastomer composition according to claim 3, wherein the hydrogenated styrene-based thermoplastic elastomer is a hydrogenated block copolymer obtained by hydrogenating a styrene-diene block copolymer.

5. The thermoplastic elastomer composition according to claim 1, wherein the olefin-based thermoplastic elastomer is an ethylene-α-olefin copolymer.

6. The thermoplastic elastomer composition according to claim 1, wherein the thermoplastic polyester elastomer is a block copolymer comprising (a) a short chain dicarboxylic acid component, (b) a short chain dial component and (c) a long chain diol component
wherein the short chain dicarboxylic acid component (a) comprises at least one of an aromatic dicarboxylic acid and its ester-forming derivative;
wherein the short chain diol component (b) comprises an aliphatic diol, and
wherein the long chain diol component (c) comprises a polyether glycol comprising a tetramethylene oxide structural unit (unit T) represented by formula (1) and having alcoholic hydroxyl groups at both terminals thereof and a number-average molecular weight of 400 to 6,000.
T: —CH₂CH₂CH₂CH₂O— (1)

7. The thermoplastic elastomer composition according to claim 6, wherein the polyether glycol further comprises a neopentylene oxide structural unit (unit N) represented by formula (2) and has a proportion of unit N of 5 to 50 mol %.

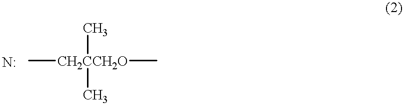

8. The thermoplastic elastomer composition according to claim 1, having a sea-island structure comprising:
a continuous phase constituted by component (A); and
a dispersed phase constituted by component (C) and having an average dispersed particle size of 1.4 μm or less.
